(19) United States
(12) Patent Application Publication
(10) Pub. No.: US 2009/0277958 A1
(43) Pub. Date: Nov. 12, 2009

(54) TRACKING SYSTEM THAT PROVIDES INFORMATION RELATED TO ELECTRONIC DEVICES

(75) Inventor: Rohan Cajetan Lobo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/306,735

(22) PCT Filed: Apr. 11, 2007
(86) PCT No.: PCT/IB07/51302

§ 371 Date: Dec. 29, 2008

Related U.S. Application Data
(60) Provisional application No. 60/806,140, filed on Jun. 29, 2006.

(51) Int. Cl. G06F 17/00

(52) U.S. Cl. 235/380; 235/375

(57) ABSTRACT

A system for use with smartcard type devices 11, 21 including a remote station 13, 23 used to interface with a smartcard type device 11, 21 to send location, time stamp information and prior usage information for the smartcard device to a central server 17, 27. The central server 17, 27 can be a tracking station or a centralized station to keeping records related to use and location of the smartcard type device 11, 21. The interface between the smartcard type device 11, 21 and the docking station can be used to make a payment, provide a map with directions, or provide information related to previous uses of the smartcard type device 11, 21. Information relative to previous locations and transactions for the smartcard type device 11, 21 can be downloaded to the smartcard, including maps and itemized lists. The smartcard type device 11, 21 allows the user to easily retrace routes and transactions from previous uses for which the smartcard type device 11, 21 was detected. The system can also allow explicit requests for former locations of the smartcard type device 11, 21 and a central server 17, 27 can return map data on how to get that particular position from the current location. The directions to the last known location may, for example, be directions to the location of the user's car in a parking garage or to a shop previously visited by the user.

The present invention relates to tracking of electronic devices, and more particularly, to tracking locations of electronic devices through the use of numerous sensing stations.

The term smart card generally refers to credit card sized cards that can interface at least in some limited manner with a remote sensing station. Smart cards contain electronics for interfacing with the remote sensing station as well as storage and/or processing of data. As used herein, the term smart card generically refers to these small electronic devices. These typical smart cards typically are used to identify persons and/or to be used as credit/debit cards to make transactions.

There are numerous types of electronics devices that can provide the functions of a smart card. Therefore, as used herein, the term “smartcard type device” is differentiated from the term smart cards as generally used. The term “smartcard type device” is intended to be inclusive of small electronic devices that are enabled with the functionality of smart cards. Therefore, the term “smartcard type device” includes smart cards, personal digital assistants (PDA), laptop computers, pagers, mobile phones, or other device capable of storing and communicating information once within range of a remote sensing device.

Interfacing with smart cards to a remote station can be accomplished either via by contact or without contact (contact-less). Interfacing without contact is accomplished at varying degrees of short ranges using techniques that are currently available and known within the art. Communications with a PDA, mobile telephone or wireless enabled small computer can take place be direct interface with a computer or wirelessly. Direct interfaces with a computer and wireless modes of communication available for devices like PDAs, mobile telephones or wireless enabled small computers are viewed herein, respectively, as being analogous to the contact and contact-less interfaces for smart cards within this document.

Smart cards can be classified as contact type or contact-less type. A contact type interfaces directly with a device capable of reading the information contained on the card or supplying information to be used/stored on the card. In the case of smart cards requiring a contact interface, the card can be inserted or touched to a card reader for operation. A contact-less card can communicate with other devices via a radio frequency interface or other electromagnetic communication interface. Once the contact-less card is within range of another device that can communicate with the card, wireless communications can take place between the contact-less card and the device.

The term Personal Digital Assistant (PDA), as used herein, refers to PDA devices that are enabled with a communication mechanism. A PDA device as used herein has communications that are analogous with those used for a contact-less type for smart card. PDA devices, pagers, wireless enabled portable computers, or mobile telephone have wireless communications that as used herein are analogous with those used for a contact-less type for smart card.

Radio frequency (RF) enables communication between smartcard devices and localized stations that can sense the smartcard device and communication with the smartcard device. Various RF implementations use different frequencies and have varying ranges. Radio frequency identification (RFID) as used in manufactured items for shipping and tracking operate over relatively long ranges on the order of 25 feet. In comparison, contact-less smart cards hand employ RF communication over only a very short range (just a matter of inches).

Contact-less type of cards have advantages that make their use desirable. A contact-less card (or PDA, mobile telephone, pager or wireless enabled laptop computer) is convenient for a user to use, and provides additional versatility that is not available using direct connection devices or contact cards.

A smartcard type device can interface with a docking station for any of a number of reasons. Interfaces with smartcard type devices (including smart cards, PDA device, pagers, mobile telephones or wireless enabled small computers) can interface with accounts, track items and store and process data. More sophisticated smartcard type devices include processors with associated electronics and displays.

The United States Department of Homeland Security (DHS) has issued a report relating to the tracking of persons entitled “The Use of RFID for Human Identification” available on the internet at http://www.dhs.gov/interweb/assetlibrary/privacy_advcom_rpt_rfid_draft.pdf. The report discusses human identification and tracking. The report appears to take the position that an identification program using RF technology could also be used for tracking as well as identification. Therefore, the report tends to be against the use of RF technology for tracking and applies this position to identification, although the report does not address tracking applications per se. There is much public sentiment against being tracked by electronic devices. This distaste for the possibility of being electronically tracked has resulted in the prior art being lacking in systems that can effectively and efficiently provide tracking services.

Most applications for RF enabled smartcard type devices simply identify items or individuals. Systems that have the capability of providing services for tracking of an individual's purchases, habits or previous locations using RF based smartcard devices as well as historical tracking of items are not readily available. It is this shortcoming within the art that the invention addresses. Many persons would enjoy a service that could organize their lives by itemizing purchases and providing recent locations of purchases as well of the locations for the numerous other uses and location detections of a smartcard type of device using of technology. There exists a need within the art for a method and system capable of providing a service for tracking of items as well as a person's habits and locations.

The current uses of smartcard type device do not provide systems and methods that effectively implement features related to the location and use of smartcard type devices. Accordingly, it is an objective of the present invention to provide such a system and method.

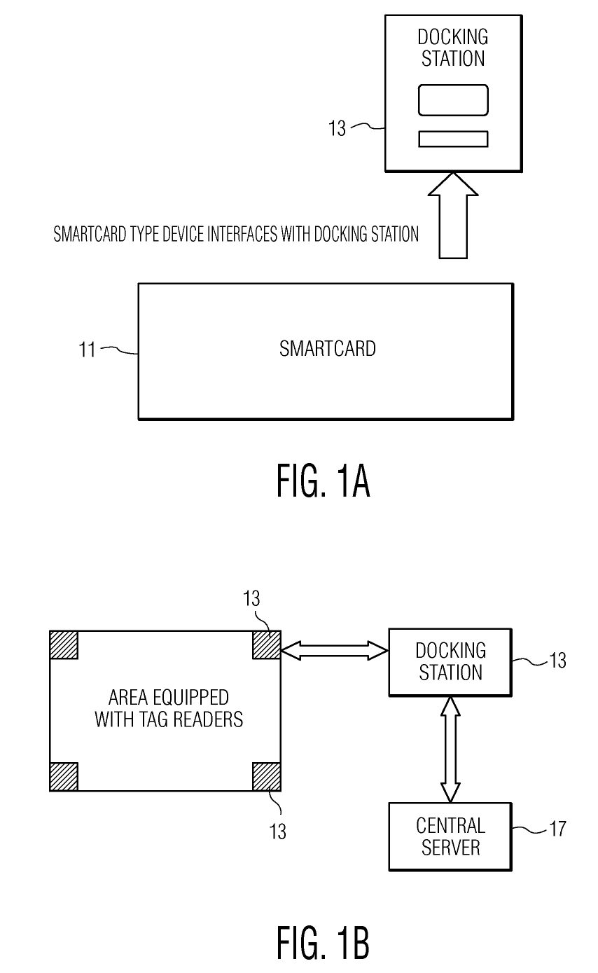

FIG. 1a is a diagram illustrating a system with a smartcard type device detection and tracking system;

FIG. 1b is a diagram illustrating a system with a smartcard type device detection and tracking system;

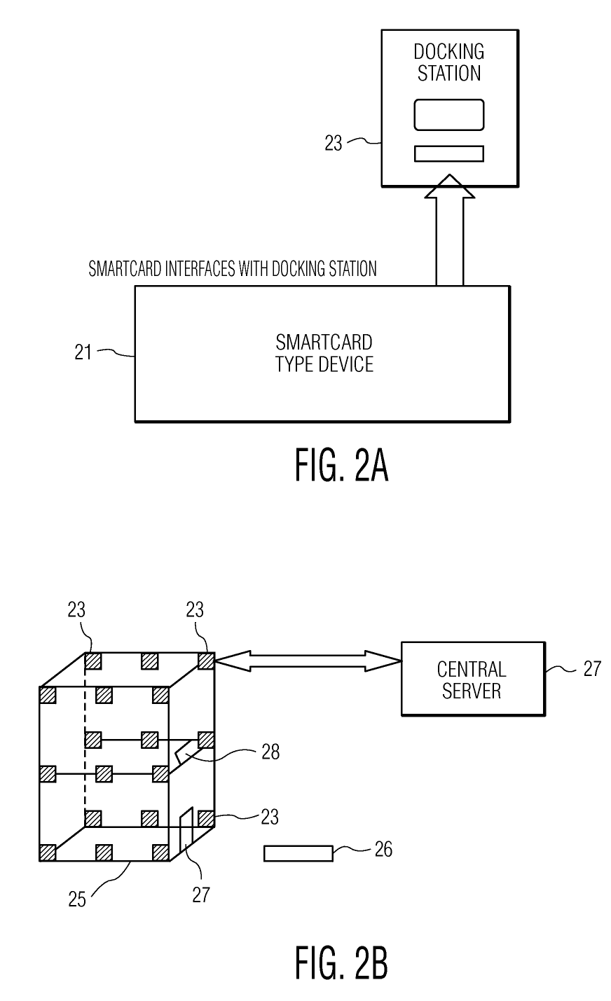

FIG. 2a is a diagram illustrating a system with a smartcard type device detection and tracking system.

FIG. 2b is a diagram illustrating a system with a smartcard type device detection and tracking system.

FIGS. 1a and 1b, are illustrations of an embodiment that can be used with a smart card type device 11 that can be either a contact type of smart card, contact-less type of smart card or other smart card type device. The smartcard type device contains electronics that can communicate and uniquely identify the smartcard type device 11. The smart card type device 11 is designed to interface with docketing stations 13, either by close proximity contact type of interface or via longer range interface such as RF. The docketing station 13 senses the presence of the smart card type device 11 and identifies the smart card type device 11. In this example, an area 15 is a place of business that is equipped with several docking stations 13, such as enabled cash register machines that can use the smartcard type device 11 to make transactions. The docking stations 13 serve as remote stations to a central server 17. A docking station 13 informs central server 17 that the uniquely identified, smartcard type device 11 has been sensed and the location of the docking station where the uniquely identified, smartcard type device 11 has been sensed. The docking station can conceivably be located at a business wherein a credit/debit card is enabled as a smartcard type device. Upon paying for an item, the docking station 13 at the business informs the central server 17 the credit/debit card has been at the business location and the purchase that has been made. At a later time, the user can use the credit/debit card to interface with another docking station, such as an Automated Teller Machine (ATM) or home computer to recall information that was previously stored on the central server 17, such as location of the business and/or the transaction that was made. Smartcard type devices equipped with a display can download the information from the central server and display, itemized lists of transactions and maps related to the locations and uses of the smartcard type device.

In another embodiment, the smart card type device 11 is inserted into a docking station 13 for a typical use. The use could be to make a payment with the smart card type device 11. The docking station 13 can download a map or directions to the last known location of the smart card type device 11, so that the user can easily retrace to the last location or the user can explicitly request any of several former locations of the card and the server returns the map or directions, or both, detailing how to get a previous location where the smart card type device was used from the current location.

In another embodiment, a user with the smart card type device enters an area 15 that is equipped with a plurality of docking stations 13 that operate as remote stations for central server 17. The remote stations can be adapted with RF to provide for communication with the central server 17. The central server 17 contains software to provide a tracking system. The remote stations formed of docking stations 13 are only a few of the entire number of remote stations that report to the tracking system contained at the central server 17. A smart card type device 11 equipped with RF (such as RFID) comes within range of one of the docking stations 13. The docking stations 13 then act as remote stations for central server 17 and provide data to the central server related to the current position of the smartcard type device 11. The user of the smartcard type device may later interface with a docking facility that can interface with the central server 17 and identify area 15 as a place where the smartcard type device was sensed. The central server 17 can provide the smartcard type device with information related to the location of smartcard type device as various previous points in time. The smartcard type device can be adapted to receive data from the docking station 13 acting as a remote station to central server 17. The smartcard type device can further be provided with a display screen capable of presenting various screens and visual representations of the data received from the docking station 13. Mapping data can be received from the docketing facilities provided by the remote station. The smart card can receive mapping data related its current position within display screen. The tracking system can be enabled to interface with the smartcard type device to provide data related to the current location and previous locations of the smartcard type device. The data provided by the tracking system can also be more than simply tracking related. The data provided by the tracking system can also be account data, transaction data or any other data associated with location or use of the smartcard type device.

Another embodiment of the invention envisions using a radio frequency identification (RFID) tracking system that registers position of the smartcard type device and downloads a map to the last known location or a number of previous locations of the card.

A smartcard may be a card that contains a display (such as a flexible LCD, LCD, OLED, an electronic ink display or other type of display), a standard smart card processor (such as Philips Smart MX), and a rechargeable battery, or it can be any device that has the above characteristics such as a PDA, mobile telephone, electronic pager or small computer.

Several interesting applications for a smartcard type device as proposed are presented below.

RF transmissions can be used to transmit signals over vast distances. Interfacing smart card type devices to remote stations over small distances can be expanded to cover several hundred feet, or several hundred yards. The shipping and tracking of items can be greatly simplified by using tracking devices that are substantially smart card type devices. Currently, items that are shipped are tagged with devices that can be detected, but use tagging techniques that do not allow for updating of the items location. It is envisioned in an embodiment that a tagging device can include a more powerful mode of transmission to enable tracking of an item by having remote sensors sense is scanned in by a reader. These enhanced tagging devices should be considered smartcard type devices as used herein. Replacing tagging techniques with a somewhat more sophisticated smart card type device that is RF enabled allows for more updated and accurate information related to tracking and shipment of items. Additionally, tracking systems can be made that require fewer tagging devices by using more sophisticated smart card type tagging devices. Instead of electrically tagging in mass, a smart card type device arrangement can be used to interface with remote stations in various places and provide more up-to-date information regarding the current location, as well as the former locations of the items. Items are then more easily tracked by using remote stations that are interfaced with the RFID (or other communication device) enabled smart card type device.

Another embodiment envisions a user on vacation who, while sightseeing, has bought a new dress from a shop she saw on the way. In order to purchase the dress, the user used a credit/debit smart card type device 11 having a display. Upon reaching home, she notices that the dress has a broken zipper and desires to return it. She inserts her smartcard type device 11 into an Automated Teller Machine (not shown) machine near her hotel and finds the transaction related to the purchase of the dress. She can then request a map and/or directions to the store to be downloaded to her smartcard type device 11 credit/debit card. The ATM downloads either a map or instructions, or both, detailing how to reach the store from this current ATM machine location, enabling the user to retrace her steps back to the store where she purchased the dress.

Another embodiment envisions a user of a smartcard type device 11 parking his or her car on a street lined with parking meters. Each of these parking meters is integrated with a remote station 13 interfacing to a central server 17 with a tracking system and registers the location of his smartcard type device 11. The meters act as remote stations 13 and interface with a central server 17. If the user forgets the street where the car is parked, he or she can go to the nearest parking meter (or remote station 13) and enter his or her smartcard type device 11 and download a map or instructions, or both, guiding him or her to the last known location of the smartcard type device 11, thus taking the user back to where his or her car is parked.

An embodiment employs smartcard type devices having displays to track and provide data related to the usage and/or location of the smartcard type devices. Tracking can be provided for location and usage of the smartcard type device 11. A smartcard interface provides communications to a remote station 13 that communicates with a central server 17. The central server 17 can then communicate with the smartcard type device 11 (including smart card, PDA device, pagers, mobile telephone or wireless enabled small computer). The central server can track the current location of the smartcard type device and provide data relative to the current location or former locations of the smartcard. Maps can be provided from the central server for the current location of the smartcard type device as well as for former locations of the smartcard type device. Lists of transactions that have been made using the smartcard type devices can be communicated from the central server to the smartcard type device. It is envisioned that maps can be generated using the current location or various combinations of former locations with or without the current location. Furthermore, locations for places of use of the smartcard type device can be shown on the map.

Another embodiment envisions smartcard type devices 11 interfacing with remote stations 13. The remote station 13 interface can be via a contact type docking station 13 used with smartcard type devices 11. The remote station 13 interface can also be via contact-less type docking station such as radio frequency (RF) or wireless communication. The smartcard type device 11 interfaces with the remote station 13 creating a docking station. Once docked (interfaced) with the docking station, the smartcard type device 11 can be used in various ways. For example to make a payment, retrieve a map with directions to a former location of the smartcard such as the last known location can be downloaded at the docking station, so that the user can easily trace his last required location (or of a more previous location of the smart card) or the user can explicitly request another position of the card and the server returns the map data on how to get that particular position from the current location.

Another embodiment of the invention envisions area 15 being used to track shipments of items that are tagged with RF based tracking devices. Over a relatively short distance, the RF based signal could be sensed at various points during shipment and delivery of items tagged with devices that emit such an RF based signal. At various points along truck routes or airports, sensing remote stations 13 sense and interface with the RF tagged items, and provide a central server 17 with up-to-date information that could be used to map the movement of RF tagged items. The whereabouts of the RF tagged items is current to the last known location.

An embodiment that employs a contact type of smart card 21 is described with reference to FIGS. 2a and 2b. The docking station 23 acts as a remote station for central server 27. Central server 27 can be located near the parking garage 25 or at a more remote location and contains a tracking system for the garage 25. A user with a contact type smart card 21 enters a parking garage 25 that is enabled with a plurality of docking stations 23 in a car 26 and swipes the contact type smart card 21 at one or more of the remote stations 23. A first swipe could occur upon entering garage 25 at the entrance 27. A swipe would occur once the car 26 of the user is placed in parking spot 28 and the user swipes the smart card 21 upon a docking station 23. The docking stations 23 can communicate with the central server 27 via an RF interface to provide for communication with the tracking system or the docking stations 23 could be hardwired with the central server 27. The smart card 21 can interface within the docketing facilities provided by the remote station. The smart card is adapted to receive data the central server 27 via docking station 23. The smart card further has a display screen capable of presenting various screens and visual representations of the data received from the docking station 23. Mapping data can be received from the docking station provided by the tracking system at the remote server. The smart card 21 can receive mapping data related its current position within display screen. The tracking system can also interface with the smart card 21 through docking station 23 to provide data related to the smart card's current location and previous locations. Once the user comes back to pay for parking, the user inserts his or her smart card 21 into a docking station 23. The smart card 21 can be used for payment. While payment is being made, the docking station 23 queries the central server 27 for the last known location of the smart card and downloads instructions and/or a map on how the user can go back to the car that was previously parked in the parking garage 25.

In another embodiment, the data provided by the central server 27 can be account data, location data, transaction data or the like. The central server 27 at or near the parking garage 25 becomes activated by docking stations 23 detecting smart card 21 and interfaces to smart card 21 through the docking stations 23 to provide expanded facilities related to the smart card 21. The central server 27 can provide tracking of the smart card within the parking garage 25 and also provide for monitoring of the location of this smart card as well as locations were the smart card has previously been used. Various alternatives are possible for the central server 27 to be located at or near the garage 25 or a more remote location. The central server 27 can be configured with data to process data related to use of the smart card 21 at different locations and provide the smart card 21 with data related to the location of the garage as well as previous locations of the smart card 21. The central server can also be configured to process data related to the use of the smart card 21 to the smart card 21 through one of the docking stations 23. The smart card 21 can carry a map indicating where the car 26 is parked in the garage 25. The smart card can also carry a local map indicating how to get back to the garage 25

Still referring to FIG. 2, another embodiment includes a system wherein the docking stations 23 are remote stations configured with RFID readers networked together to report to central server 27 regarding the location of car 26. In this embodiment, the smart card 21 is a contact-less smartcard type device that is RF enabled allowing the docking stations 23 to track the location of the smart card 21, and continuously send location information as well as the time stamp back to the central server 27 where this information is stored and processed.

Still referring to FIGS. 2a and 2b, in another embodiment, a user with a smartcard type device 21 enters a parking garage 25 that has docking stations 23 enabled with RFID sensors that can detect the smartcard type device 21. The smartcard type device 21 is enabled with RF to provide detection capabilities for the RFID sensors in the docking stations. The smartcard type device 21 can be enabled with an RFID device that provides detection within, for example, 25 feet of the RFID sensors within the docking stations 23. Upon detection of the RF enabled smartcard device 21, the docking stations 23 activate the tracking system within the central server 27 at or near the parking garage and provide data that allows the monitoring of the location of the smartcard device 21. Using the tracking system, the central server can provide the smartcard type device 21 with data related to the location of the smartcard type device 21.

Additionally in another embodiment, the central server at or near the garage 25 can function to transfer data related to uses of the to smartcard type device 21. In this embodiment, the central server 27 may not be at the garage 25 but at a different location. Alternatively, the central server 27 can interface with a remote server at the different location to provide the smartcard type device with data related to location and use of the smartcard type device. This data can include not just data in relation to the parking garage, but also data related to other locations at which the smart device has been detected or used.

Embodiments are envisioned for users who park a car 26 in a parking slot 28 in the parking garage 25. A smartcard type device 21 reader within the docking station 23 sends the current location of this smartcard type device 21 back to the central server 27. The smartcard type device 21 has a display and processing circuitry with associated memory. The display on the smartcard type device 21 can display information received from the central server 27. The central server 27 can be near the parking garage or at a more remote location. In those instances in which the smartcard type device 21 is a contact type of smart card, the user contacts the smart card to the docking station 23 in order to initiate the necessary interface between the smartcard type device 21 and the docking station. In cases where the smartcard type device 21 is contact-less: such as contact-less smart cards, PDAs, pagers, mobile telephones and small computers, can interface with the remote stations 23 while within a certain range. Ranges vary from inches to a few feet for contact-less smart cards to 25 ft. or more for RF devices. The user parks the car 26 in a parking slot 28 in the parking garage 25, and the remote station 23 sends the current location of this smartcard type device 21 back to the central server 27. The central server 27 retains the positional information for the car 26 by retaining the position of smartcard type device 21 received from slot 28 where the car was parked.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof,
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A tracking system comprising:
a smartcard type device (11, 21) configured with a communication device that can communicate information with a plurality of remote stations (13, 23);
a central server (17, 27) that is capable of retaining and communicating with the remote stations (13, 23) information relayed to the smartcard type device (11, 21); and
a processing device associated with the central server (17, 27) that processes information related to the smartcard type device (11, 21);
wherein, information related to the smartcard type device (11, 21) is communicated from at least one of the remote stations (13, 23) to the central server and processed information related to the smartcard type device (11, 21) is communicated from the central server (17, 27) to the smartcard type device (11, 21) via the remote station (13, 23).

2. The system of claim 1 wherein the central server (17, 27) provides tracking information for the smartcard type device (11, 21).

3. The system of claim 1 wherein the communication device of the smartcard type device (11, 21) interfaces with the remote station (13, 23) via radio frequency waves.

4. The system of claim 1 wherein the communication device sends location information to the remote station (13, 23) and the processing system provides mapping information for the smartcard type device (11, 21) related to at least one former location of the smartcard type device (11, 21).

5. The system of claim 1 wherein the communication device sends timestamp information to the remote station (13, 23).

6. The system of claim 1 wherein the remote station (13, 23) stores information received from the smartcard type device (11, 21).

8. The system of claim 1, wherein the remote station (13, 23) is a docking station (13, 23) and the smartcard type device (11, 21) is configured to interface with and receive information from the docking station (13, 23).

9. The system of claim 1 wherein the communication device interfaces with the remote station (13, 23) and the processing system provides information related to prior use of the smartcard type device related to at least one former location of the smartcard type device (11, 21).

10. The system of claim 1, wherein the smartcard receives information at the docketing station (13, 23) related to use of the smartcard type device (11, 21) including at least one of: at least one traced location; a map related to uses of the smart card that can be downloaded into the smartcard; a payment that has previously being made; a current payment being made; or a list of uses for the smartcard.

11. A tracking system comprising:
an electronic device configured with a communication device that can communicate information with a plurality of remote stations (13, 23);
a server capable of retaining and communicating with the remote stations (13, 23) information related to electronic device; and
wherein, information related to the electronic device is communicated from at least one of the remote stations (13, 23) to the server and processed information related to the electronic device is communicated from the server to the electronic device via the remote station.

12. The system of claim 11 wherein the server provides tracking information of the electronic device.

13. The system of claim 11 wherein the communication device of the electronic device interfaces with the remote station (13, 23) via radio frequency waves.

14. The system of claim 11 wherein the communication device sends location information to the remote station (13, 23) and the processed information includes mapping information for the electronic device related to at least one former location of the electronic device.

15. The system of claim 11 wherein the communication device sends timestamp information to the remote station (13, 23).

16. The system of claim 11 wherein the remote station (13, 23) stores information received from the electronic device.

18. The system of claim 11, wherein the remote station (13, 23) is a docking station and the electronic device is configured to interface with and receive information from the docking station.

19. The system of claim 11 wherein the communication device interfaces with the remote station (13, 23) and the processed information includes information related to prior use of the electronic device related to at least one former location of the electronic e device.

20. The system of claim 11, wherein at least one remote station (13, 23) is a docking station and the electronic device receives information at the docking station related to use of the electronic device including at least one of: at least one traced location; a map related to use of the electronic device that can be downloaded into the smartcard; a payment that has previously being made; a current payment being made; or a list of uses for the electronic device.
